(19) United States
(12) Patent Application Publication
(10) Pub. No.: US 2014/0033731 A1
(43) Pub. Date: Feb. 6, 2014

(54) Method for fuel temperature control of a gas turbine

(71) Applicant: Rolls-Royce Deutschland Ltd & Co KG, Blankenfelde-Mahlow (DE)

(72) Inventor: Leif RACKWITZ, Rangsdorf (DE)

(73) Assignee: Rolls-Royce Deutschland Ltd & Co KG, Blankenfelde-Mahlow (DE)

(21) Appl. No.: 13/957,606

(22) Filed: Aug. 2, 2013

(30) Foreign Application Priority Data
Aug. 3, 2012 (DE) 10 2012 015 454.2

(51) Int. Cl. F02C 9/28; F02C 7/264; F02C 7/224

(52) U.S. Cl. CPC F02C 9/28; F02C 7/224; F02C 7/264
USPC 60/776; 60/772

(57) ABSTRACT

The present invention relates to a method for controlling the fuel temperature of a gas turbine, where parameters are determined as input values, where the parameters are compared with emission-optimized nominal values and an optimum fuel temperature is determined, and where the fuel to be supplied to a combustion chamber is heated or cooled.

This invention relates to a method for fuel temperature control of an aircraft gas turbine.

It is known that the fuel temperature has a major influence on fuel/air mixture formation and hence on combustion properties. When the fuel temperature rises, the dynamic viscosity and the surface tension of the fuel fall, so that faster evaporation and hence more intensive atomization can be achieved. In aircraft engines, the liquid fuel is heated to different degrees by various units of the fuel system, from the fuel tank in the aircraft until injection into the combustion chamber, as a consequence of variable operating conditions during the flight cycle and due to the heat exchange along the fluid path. A component frequently used in aircraft gas turbines is for example the FCOC (Fuel Cooled Oil Cooler), which conveys heat from the oil circuit into the fuel circuit. The fuel temperature can therefore fluctuate widely over the flight cycle, depending on the design of the fuel system and of any control equipment, and is influenced to a high degree by the heat exchange with other components. A change in the fuel temperature causes an effect on the combustion chamber behaviour.

An important boundary condition for the variation of the fuel temperature is the occurrence of thermal decompositions of the fuel. As of approx. 150° C., oxidation reactions with the oxygen present in the fuel take place, and at temperatures above 480° C. pyrolysis reactions also occur. In addition to the risk of fuel coking triggered by pyrolysis, fouling (contamination) of the fuel is also known, where certain chemical constituents precipitate out of the fuel starting at a fuel temperature of >100° C. and can lead to deposits. These phenomena can, depending on the thermal prestressing of the fuel, the flow characteristics of the fuel system and other key characteristics, lead to increased deposit problems and in the final analysis to malfunctions of fuel system components. The state of the art proposes for example a selective reduction of the oxygen content present in the fuel (“deoxygenated systems”).

In automotive engineering, methods for controlling the fuel temperature in order to improve engine performance were already proposed some years ago or are already in use. In this connection, reference is made to EP 2 028 362 A2 for an internal combustion engine to be operated with a high-viscosity fuel, where a device and a method are indicated for fuel temperature control using a heat exchanger.

U.S. 2011/0203291 A1 proposes a shortening of the fuel line length between the tank and the engine and uses a cold line and a hot line, with the respective fuel being mixed. Further control steps are not previously known from the publication. In particular, no specifically defined fuel temperature is provided. A similar procedure is described by U.S. 2010/0107603 A1, where the fuel is heated by means of a reversible heat exchanger.

The state of the art thus shows only procedures in which a required fuel temperature is set with regard to the calorific value of various fuels, but where the operating states of the aircraft are not taken into account. Reference is made only to the correlation between fuel temperature and calorific value, obtained for example from the Wobbe index.

Although the fuel temperature has a marked influence on the combustion properties, it is often not specifically used as a parameter for optimization when the engine/combustion chamber is designed, with the result that the combustion chamber is not operated in an optimum way. For example, low fuel temperatures after a lengthy dwell time following blow-out of a combustion chamber in cruising conditions can cause a deterioration of the ignition properties, which can have a considerable detrimental effect on the operating behaviour of the engine. On the other hand, a significant change in the emission behaviour of the combustion chamber or the engine, respectively, can occur due to a change in the fuel temperature, in particular as regards the NOx-CO characteristics.

The object underlying the present invention is to provide a method for controlling an optimum fuel temperature of an aircraft gas turbine, which takes into account differing operating conditions of the aircraft gas turbine and in particular permits both optimized pollutant emissions and an optimized re-ignition of the aircraft gas turbine.

It is a particular object of the present invention to provide solution to the above problematics by the features of claim 1. Further advantageous embodiments of the method according to the present invention become apparent from the sub-claims and the independent Claims.

In accordance with the invention, a method is thus provided for controlling the fuel temperature of an aircraft gas turbine, where engine parameters are determined as input values, where these engine parameters are compared with emission-optimized nominal values and where an optimum fuel temperature is determined, with the fuel to be supplied to a combustion chamber being heated or cooled subsequently.

The operating parameters to be determined in accordance with the invention are for example the flight altitude, the temperature at the combustion chamber outlet and the inlet pressure into the combustion chamber. These engine parameters are measured or determined by calculation.

The defined engine parameters are used in the method in accordance with the invention as input values and are compared with nominal values obtained from previously stored fields of characteristics.

In a favourable development of the method in accordance with the invention, it is provided that when an acceleration or deceleration state of the aircraft gas turbine is detected, the nominal value of the fuel temperature is set to a value prevailing before implementation of the method. The fuel temperature is therefore set to a value that originally prevailed or that prevailed prior to the procedural sequence stated above.

Furthermore, a method for controlling the fuel temperature of an aircraft gas turbine is provided in accordance with the invention, in particular using the method described above, where the issue of an ignition command by a pilot or by an electronic engine control or regulation system is determined, where the maximum permissible temperature of the fuel is subsequently determined for an ignition process and where the fuel is heated to the maximum temperature.

In a favourable development of the method in accordance with the invention, it is provided that the optimum or the maximum nominal temperature of the fuel is then compared with a maximum permissible fuel temperature, and when the maximum permissible fuel temperature is exceeded the fuel is not heated to a temperature above the maximum permissible fuel temperature.

Furthermore, it can be particularly advantageous in accordance with the invention that in the case of a non steady-state flight condition the fuel temperature is set for a limited period of time above a first limit value but below a further upper limit value. It can be favourable here when the fuel temperature is always set above a minimum limit value.

In a development in accordance with the invention, it is provided that the fuel is heated by means of a separate heating device and cooled by means of a separate cooling device, with the heating device and/or the cooling device being used separately or simultaneously.

When a separate controller is used, the heating device and the cooling device are used preferably by means of a hysteresis function in order to prevent an unintentionally too fast switchover of the controller.

In accordance with the invention, the fuel can be optionally additionally heated by means of an oil/fuel heat exchanger. It is furthermore possible in accordance with the invention to achieve heating and/or cooling of the fuel by mixing colder and warmer fuel.

The following advantages in particular are obtained in accordance with the invention:
Optimization of the emission characteristics of the aircraft engine over the flight cycle, potential for reduction of NOx emissions/optimization in respect of increased combustion chamber burn-out/reduced fuel consumption (reduced CO emissions).
Extension of the lean blow-out and ignition limits of the combustion chamber, which can lead to an improvement of the starting behaviour of the engine.
Improvement of the acceleration behaviour of the engine from ignition until the idling state is reached.
The improvement of the ignition behaviour of the combustion chamber results in the possibility of reducing the combustion chamber volume (in particular of the primary zone), which is a key parameter for influencing the ignition characteristics of the combustion chamber. Advantage: further NOx reduction very probable, lower component weight, SFC reduction.
Lessening of ice crystal formation in the fuel during flight conditions with very low outside temperatures or reduced fuel temperatures in the aircraft tank.

The present invention is described in the following in light of the accompanying drawing, showing exemplary embodiments. In the drawing,

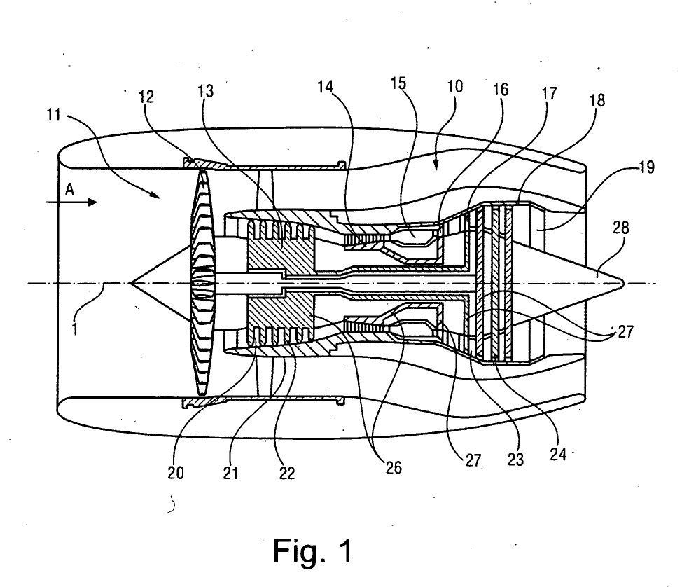

FIG. 1 shows a schematic representation of a gas-turbine engine in accordance with the present invention,

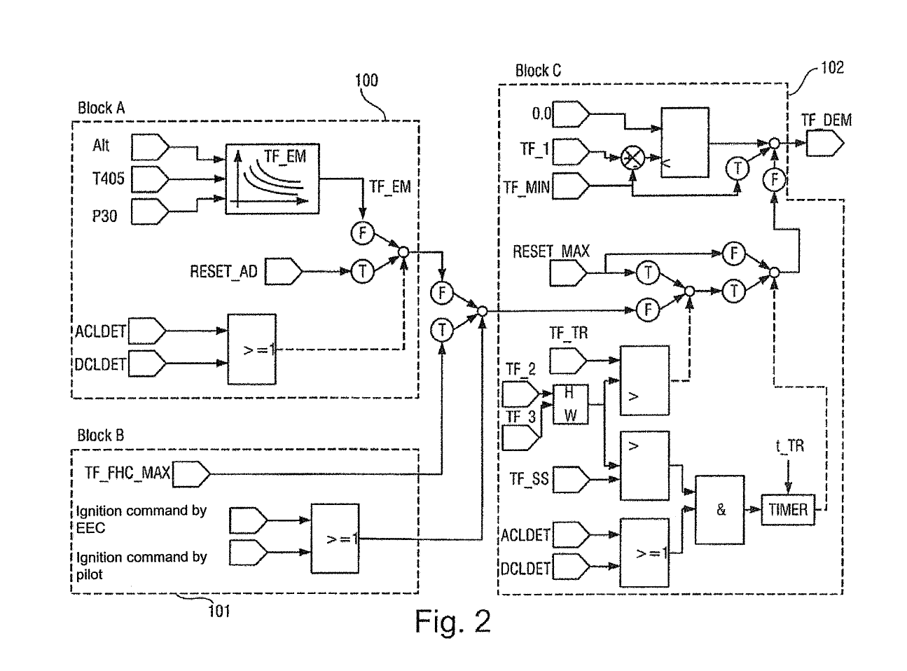

FIG. 2 shows a representation of three control blocks, i.e. a block A for fuel temperature control as regards the requirements on pollutant emissions, a block B for temperature control as regards the requirements on the re-ignition behaviour and a block C for limitation of fuel temperature control,

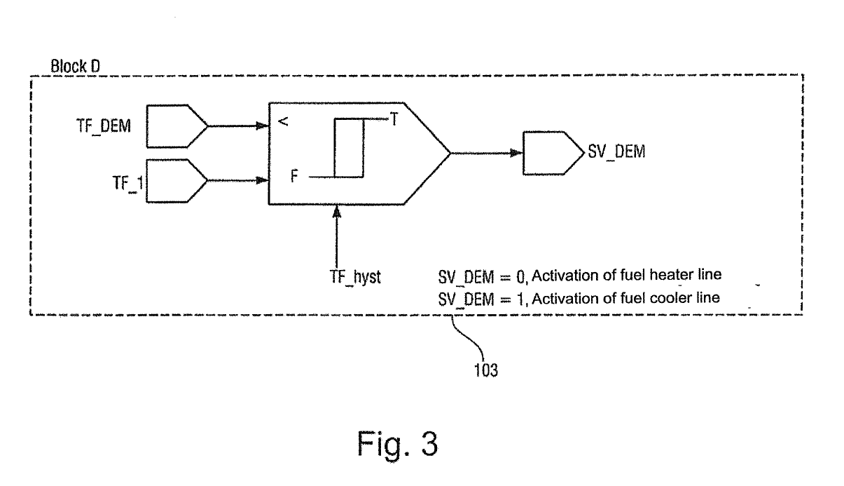

FIG. 3 shows a representation of a further control block D for activating a solenoid valve,

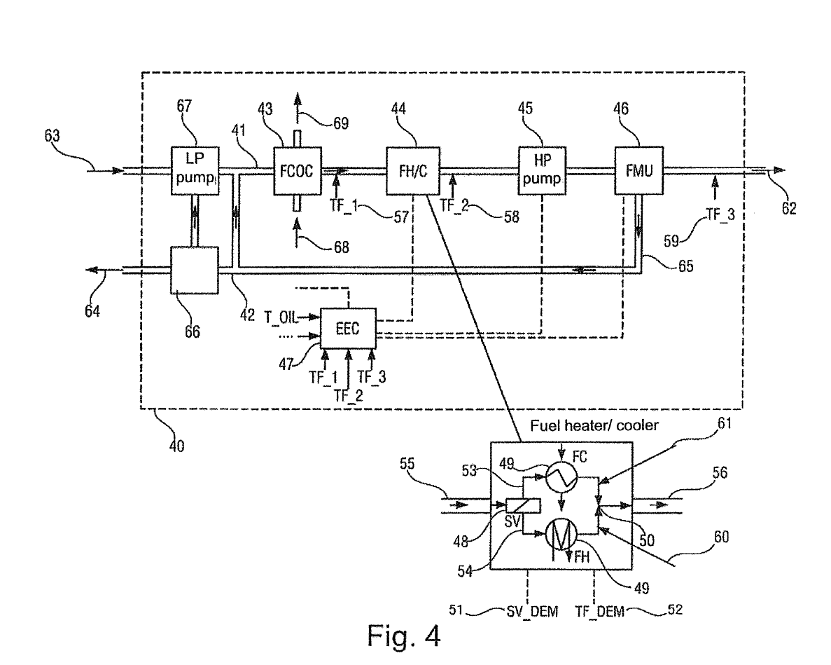

FIG. 4 shows a representation of the components for carrying out the method in accordance with the present invention (exemplary embodiment),

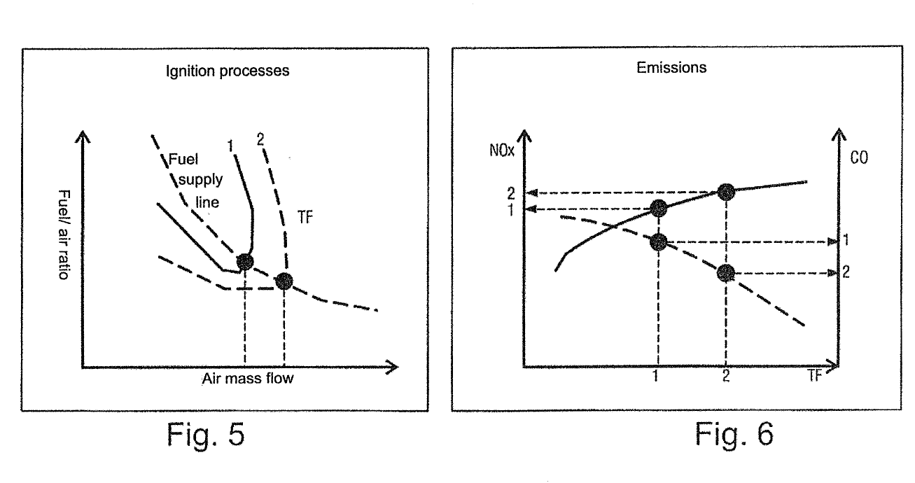

FIG. 5 shows the correlation between the air mass flow and the fuel/ air ratio in ignition processes,

FIG. 6 shows the correlation between fuel temperature and emissions, and

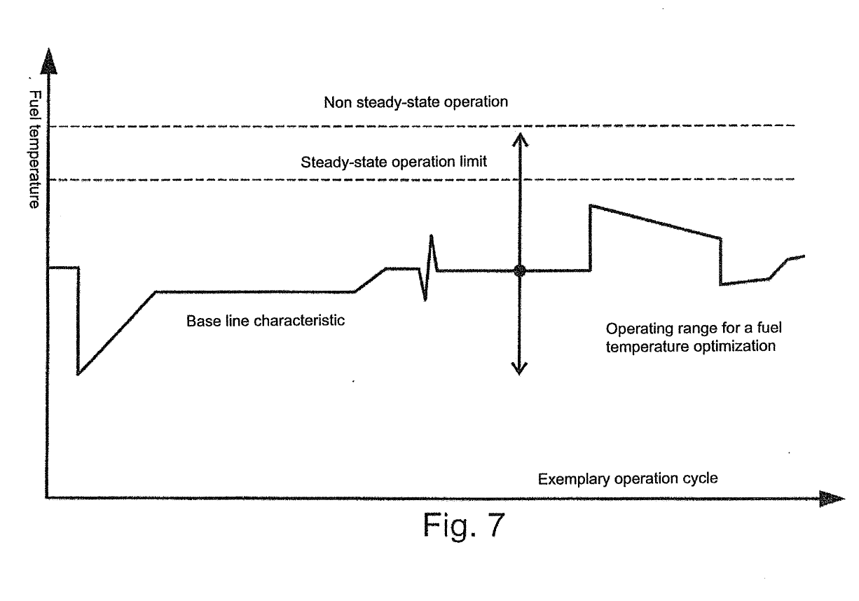

FIG. 7 shows a representation of the fuel temperature over an exemplary operation cycle.

The gas-turbine engine 10 in accordance with FIG. 1 is a generally represented example of a turbomachine where the invention can be used. The engine 10 is of conventional design and includes in the flow direction, one behind the other, an air inlet 11, a fan 12 rotating inside a casing, an intermediate-pressure compressor 13, a high-pressure compressor 14, a combustion chamber 15, a high-pressure turbine 16, an intermediate-pressure turbine 17 and a low-pressure turbine 18 as well as an exhaust nozzle 19, all of which being arranged about a center engine axis 1.

The intermediate-pressure compressor 13 and the high-pressure compressor 14 each include several stages, of which each has an arrangement extending in the circumferential direction of fixed and stationary guide vanes 20, generally referred to as stator vanes and projecting radially inwards from the engine casing 21 in an annular flow duct through the compressors 13, 14. The compressors furthermore have an arrangement of compressor rotor blades 22 which project radially outwards from a rotatable drum or disk 26 linked to hubs 27 of the high-pressure turbine 16 or the intermediate-pressure turbine 17, respectively.

The turbine sections 16, 17, 18 have similar stages, including an arrangement of fixed stator vanes 23 projecting radially inwards from the casing 21 into the annular flow duct through the turbines 16, 17, 18, and a subsequent arrangement of turbine blades 24 projecting outwards from a rotatable hub 27. The compressor drum or compressor disk 26 and the blades 22 arranged thereon, as well as the turbine rotor hub 27 and the turbine rotor blades 24 arranged thereon rotate about the engine axis 1 during operation.

The present invention proposes a selective change in the fuel temperature depending on the operating conditions of the engine, in order to improve the combustion properties and thereby improve engine behaviour.

FIG. 5 shows an exemplary ignition curve for a combustion chamber, shown as an air/fuel mass flow ratio (Air Fuel Ratio, AFR) as a function of the combustion chamber air mass flow (W30). The ignition curve indicates the AFR-W30 range in which successful ignition of the combustion chamber is possible. It can be seen that an increase in the fuel temperature TF (state 2) permits an extension of the ignition limits. This means that the probability of a successful engine restart can be improved or that the ignition limit is shifted in the direction of higher flight altitudes.

FIG. 6 shows schematically a NOx-CO emission characteristic where a contrary trend between NOx and CO can occur depending on the fuel temperature. The important factor is that the level of the individual pollutant emissions (for example NOx, CO, UHC, soot) can be changed by changing the fuel temperature.

FIG. 7 shows schematically a typical curve of the fuel temperature over a flight cycle. Additionally, maximum values for the fuel temperature in steady-state and transient operation of the aircraft engine are entered (“steady state limit”, “transient limit”). The absolute values of the fuel temperature depend here on a number of factors, for example the thermal behaviour of the fuel system and the ambient conditions, but it can be seen that adaptation of the fuel temperature (increase or decrease) is possible within known limit values.

The dependencies of the combustion chamber operating parameters on the fuel temperature (FIG. 5, FIG. 6) and also due to the possible range in the variation of the fuel temperature within known limit values (FIG. 7) are used in the present invention as a basis for improving the operating properties of an aircraft engine.

It is proposed in the present invention to selectively adapt the fuel temperature for optimization of the operating properties of an aircraft engine. This includes on the one hand a software algorithm for controlling a unit for adaptation of the fuel temperature (software), that can be integrated into the existing electronic engine controllers (EEC). On the other hand, the present invention proposes the operating principle of the unit for adaptation of the fuel temperature (FH/C=Fuel Heater/Cooler).

FIG. 2 shows the control algorithm in accordance with the present invention for the software of an engine controller. The algorithm consists of 3 main logic blocks: in the first block A (100) “Fuel temperature demand for emissions”, an optimum fuel temperature for low emissions (TF_EM) is calculated depending on calculated or synthesized engine parameters. Since this is a passive control, the appropriate characteristics are obtained from combustion chamber or engine tests. The calculated value TF_EM is used as the nominal value for control of the fuel temperature in respect of the emissions. If an acceleration or deceleration manoeuvre of the engine is detected, the commanded value is reset (by means of RESET_AD).

In a further block B (101) “Fuel temperature demand for ignition”, a maximum temperature for the fuel is defined (TF_FHC_MAX). If an ignition process of the combustion chamber is detected (either automatically by the engine controller or caused by manual actuation by the pilot in the cockpit), the command TF_EM is overwritten by TF_FHC_MAX. This ensures that the ignition limits of the combustion chamber are extended and the probability for a successful ignition is increased. This means that during an ignition process, it is always the maximum value of the fuel temperature which is commanded, regardless of the calculated fuel temperature in block A.

In a further block C (102) “Fuel temperature limitation”, the measured fuel temperatures TF_2 and TF_3 are compared with defined maximum values during a steady-state or transient operation of the engine, and if necessary limited (see FIG. 2). If the value for the fuel temperature TF_2 or TF_3 exceeds the maximum value TF_TR, the commanded value is reset by means of RESET_MAX. This ensures that the fuel temperature does not exceed the maximum value in any operating state. If TF_2 or TF_3 is above the value of the fuel temperature TF_SS permissible in steady-state operation of the engine but below the maximum value TF_TR, an increase in the fuel temperature for a predefined time t_TR is permitted in the case of detection of a non steady-state manoeuvre of the engine. If after the permissible time interval an increased fuel temperature TF_2 or TF_3 above TF_SS is still determined, RESET_MAX again takes effect and resets the commanded value of the fuel temperature. The final commanded value of the fuel temperature TF_DEM is used for controlling the FHC unit.

A further function of the logic block C consists in the limitation of the fuel temperature when a minimum limit value (TF_MIN) is undershot. If the measured value of the fuel temperature TF_1 falls below this limit value, then the value TF MIN is used as the final commanded fuel temperature. This is intended to ensure that precipitation of wax crystals, which can lead to a porous wax medium of the fuel, does not occur at any time. A progressive macroscopic solidification of the mixture can lead to ice crystal formation within the fuel system. For Jet A-1, a mean value of the freezing point of approx. −52° C. was determined. The value TF_MIN defined in the proposed logic is supplemented by an additional safety factor and is therefore above the freezing point of the fuel (i.e. higher minimum fuel temperature).

In a further block D (103), the nominal value for controlling the solenoid valve (electromagnetic valve) is determined (FIG. 3). If TF_DEM<TF_{—}2, then SV_DEM=1 is set. This means that the solenoid valve is opened, so that inside the FH/C the second fluid line is filled with fuel. This branch is used for cooling of the fuel. If however TF_DEM>TF_{—}2, then the fluid line 2 is closed and only the fluid line 1 is filled. In this case, the fuel is heated up using the control variable TF_DEM. There is a hysteresis between the two states, where the width of the hysteresis function is defined by TF_hyst, which is intended to prevent cyclic switching between the two states. The position of the temperature measuring point for TF_2 and TF_3 is shown in FIG. 4 as an example, but it can also be at other positions inside the fuel system. Furthermore, instead of two or more temperature measuring points in a further design variant, it is possible to use only one temperature measuring point, where the proposed control software then only uses one measured temperature in the fuel system for calculation of the nominal value for the fuel temperature.

A further design provides for parallel operation of the fuel preheater and of the fuel heater.

FIG. 4 shows schematically a possible implementation of the FHC unit for a fuel system (40). An important aspect of the present invention is the setting and the selective monitoring of the fuel temperature. To determine the fuel temperature, one or more temperature probes (57, 58, 59) should be integrated into the fuel lines: TF_1 downstream of a FCOC (Fuel Cooled Oil Cooler), TF_2 downstream of one or more FH/C units and TF_3 between the FMU (Fuel Metering Unit) and the fuel nozzles. In a further advantageous embodiment of the invention, at least one electric fuel preheater for the FHC is proposed which causes a temperature increase in the fuel by heating, for example operating as a thermostat, with coils, plates etc. and being appropriately flushed with fuel. If however SV_DEM=1 is calculated for the commanded nominal value, heating of the fuel is switched off. In a further embodiment, a temperature increase of the fuel can be achieved by switching over between various fluid paths in the fuel system or by improved exploitation of the existing temperature gradient inside an existing fuel system. If cooling of the fuel relative to the measured values is commanded, this can for example be achieved by one or more appropriately designed surface heat exchangers.

It should be mentioned here that the predefined limit values for the fuel temperature (TF_SS, TF_TR) can be considerably increased by a reduction of the oxygen content present in the fuel (“deoxygenated systems”), or in the extreme case are no longer necessary since the decomposition/precipitation processes in the fuel then no longer occur.

The presence of a FCOC is not necessary, and hence optional. The invention thus relates to a variant with/without FCOC.

In a further embodiment of the invention, the valve 48 can also be designed as a metering valve, where a certain ratio of “cold” (line 53) to “warm” (line 54) fuel is commanded by the appropriate control unit 47.

In the fuel heater/cooler shown in accordance with FIG. 4, the solenoid valve is a simple control valve which only switches on and off. There is no regulation, instead only switching on or switching off the heater and the cooler. This is achieved using two setting variables SV_DEM.

With regard to the FCOC, it must be noted that it is always in operation to cool the oil in the embodiment shown.

### GLOSSARY

ACLDET . . . engine acceleration detected
AFR . . . air fuel ratio
Alt . . . calculated aircraft altitude
BV . . . bypass valve
CO . . . carbon monoxide
DCLDET . . . engine deceleration detected
EEC . . . electronic engine controller
FC . . . fuel cooler
FCOC . . . fuel cooled oil cooler
FH . . . fuel heater
FH/C . . . fuel heater/cooler
FMU . . . fuel metering unit
HP . . . high pressure
NOx . . . nitrogen oxide
P30 . . . combustion chamber (combustor) entry pressure
RESET_AD . . . reset fuel temperature demand during engine acceleration/deceleration (default=0)
RESET_MAX . . . reset fuel temperature demand when TF_TR is exceeded
SV . . . solenoid valve
SV_DEM . . . solenoid valve demand
T405 . . . synthesized combustion chamber (combustor) exit temperature
t_TR . . . maximum allowed time for exceedence of TF SS
TF . . . fuel temperature
TF_1 . . . measured fuel temperature at fuel system station 1 (down-stream of FCOC)
TF_2 . . . measured fuel temperature at fuel system station 2 (down-stream of FH/C)
TF_3 . . . measured fuel temperature at fuel system station 3 (between FMU and fuel nozzles)
TF_DEM . . . final fuel temperature demand
TF_EM . . . fuel temperature demand for emissions
TF _FHC_MAX . . . maximum fuel temperature demand at fuel heater/cooler station (FHC)
TF_MIN . . . minimum fuel temperature demand
TF_TR . . . maximum allowed fuel temperature during engine transients
TF_SS . . . maximum allowed fuel temperature during steady-state engine operation

### LIST OF REFERENCE NUMERALS

1 Engine axis
10 Gas-turbine engine/core engine
11 Air inlet
12 Fan
13 Intermediate-pressure compressor (compressor)
14 High-pressure compressor
15 Combustion chamber
16 High-pressure turbine
17 Intermediate-pressure turbine
18 Low-pressure turbine
19 Exhaust nozzle
20 Guide vanes
21 Engine casing
22 Compressor rotor blades
23 Stator vanes
24 Turbine blades
26 Compressor drum or disk
27 Turbine rotor hub
28 Exhaust cone
40 Fuel system
41 Fuel line
42 Fuel line
43 FCOC
44 FH/C
45 HP pump
46 FMU
47 EEC
48 Solenoid valve
49 Fuel heater
50 Mixing point
51 Solenoid valve demand
52 Fuel temperature demand
53 Fuel line
54 Fuel line
55 Fuel return
56 Fuel outlet
57 Temperature probe
58 Temperature probe
59 Temperature probe
60 Fuel heating line
61 Fuel cooling line
62 Fuel to combustion chamber
63 Fuel from tank
64 Fuel return to tank
65 Bypass fuel return
66 Fuel return valve
67 LP pump
68 Oil inlet from engine
69 Oil outlet to engine
70 Fuel cooler

1. Method for controlling the fuel temperature of a gas turbine, where parameters are determined as input values, where the parameters are compared with emission-optimized nominal values and an optimum fuel temperature is determined, and where the fuel to be supplied to a combustion chamber is heated or cooled.

2. Method in accordance with claim 1, characterized in that when an acceleration or deceleration state of the gas turbine is detected, the nominal value of the fuel temperature is set to the value prevailing before implementation of the method, and/or the additional fuel heating or fuel cooling is switched off.

3. Method for controlling the fuel temperature of a gas turbine, where the issue of an ignition command by a pilot or by an electronic engine control system is determined, where the maximum permissible temperature of the fuel is determined for an ignition process and the fuel is heated to the maximum temperature.

4. Method for controlling the fuel temperature of an aircraft gas turbine, in particular in accordance with claim 1, where the issue of an ignition command by a pilot or by an electronic engine control system is determined, where the maximum permissible temperature of the fuel is determined for an ignition process and the fuel is heated or cooled to the maximum temperature.

5. Method in accordance with claim 1, characterized in that the optimum or the maximum nominal temperature of the fuel is then compared with a maximum permissible fuel temperature, and when the maximum permissible fuel temperature is exceeded the fuel is not heated to a temperature above the maximum permissible fuel temperature.

6. Method in accordance with claim 1, characterized in that in the case of a non steady-state flight condition the fuel temperature is set for a limited period of time above the permissible nominal value but below an upper limit value.

7. Method in accordance with claim 1, characterized in that the fuel temperature is always set above a minimum limit value.

8. Method in accordance with claim 1, characterized in that the fuel is heated by means of a separate heating device and cooled by means of a separate cooling device, with the heating device and/or the cooling device being used separately or simultaneously.

9. Method in accordance with claim 8, characterized in that the heating device and the cooling device are used by means of a hysteresis function.

10. Method in accordance with claim 1, characterized in that the fuel is optionally additionally heated by means of one or more oil/fuel heat exchanger(s).

11. Method in accordance with claim 1, characterized in that heating and/or cooling of the fuel is achieved by mixing colder and warmer fuel.
